(19) United States
(12) Patent Application Publication
(10) Pub. No.: US 2013/0148554 A1
(43) Pub. Date: Jun. 13, 2013

(54) ELECTRONIC DEVICE AND METHOD FOR SHARING CONTENTS VIA BLUETOOTH NETWORK

(71) Applicant: HON HAI PRECISION INDUSTRY CO., LTD., New Taipei (TW)

(72) Inventor: SI-QUAN CHEN, New Taipei (TW)

(73) Assignee: HON HAI PRECISION INDUSTRY CO., LTD., New Taipei (TW)

(21) Appl. No.: 13/710,479

(22) Filed: Dec. 11, 2012

(30) Foreign Application Priority Data
Dec. 13, 2011 (TW) 100145901

(51) Int. Cl. H04H 20/61

(52) U.S. Cl. CPC H04H 20/61
USPC 370/310

(57) ABSTRACT

An electronic device capable of sharing content includes a storage unit, an input unit, a wireless connection unit, and a control unit. The storage unit stores a variety of content. The control unit obtains one of the contents from the storage unit according to a selection signal from the input unit, combines the selected content with an ID packet of the electronic device to form a combined ID packet, and employs the combined ID as a new ID packet of the electronic device, thereby allowing other electronic devices to directly obtain the selected content through the new ID packet.

### BACKGROUND

1. Technical Field

The present disclosure relates to electronic devices and, more particularly, to an electronic device and a method capable of sharing contents via a Bluetooth® network.

2. Description of Related Art

Portable terminals employing a Bluetooth® module can transfer and receive resources using a Bluetooth® communication protocol. For example, Bluetooth® pushers, which include a Bluetooth® module, offer an effective and affordable solution for transmitting resources, especially for advertisement such as entertainment, discounts, coupons, and other promotional material, to a large potential customer. However, the Bluetooth pusher needs to make a connection with the peripheral devices of the customers, which makes the resource transmission procedures between the Bluetooth pushers and the peripheral devices limited, cumbersome and time consuming to set up.

Therefore, what is needed is an electronic device that can offer a more efficient, user-friendly procedure for sharing contents via a Bluetooth® network.

### BRIEF DESCRIPTION OF THE DRAWINGS

Many aspects of the present disclosure can be better understood with reference to the following drawings. The units in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a first electronic device, in accordance with an embodiment.

FIG. 2 is a block diagram of a second electronic device, in accordance with an embodiment.

FIG. 3 is a flowchart of a method of sharing contents via a Bluetooth® network between the first and the second electronic devices of FIGS. 1-2, in accordance with an embodiment.

FIG. 4 is a flowchart of a method of sharing contents via a Bluetooth® network between the first and the second electronic devices of FIGS. 1-2, in accordance with another embodiment.

FIG. 5 is a flowchart of a method of sharing contents via a Bluetooth® network between the first and the second electronic devices of FIGS. 1-2, in accordance with yet another embodiment.

### DETAILED DESCRIPTION

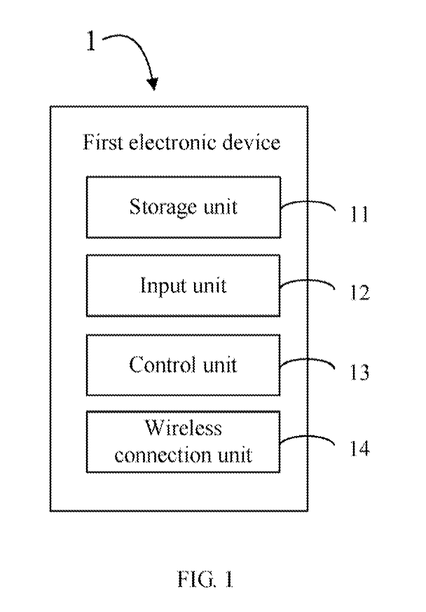

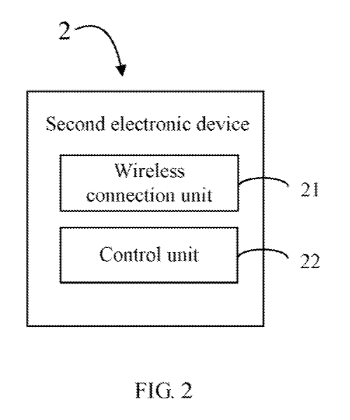

FIG. 1 is a block diagram of a first electronic device 1 according to an exemplary embodiment. The first electronic device 1, such as a computer or a mobile phone, has a function for sharing a variety of contents with at least one second electronic devices 2 (shown in FIG. 2). The content may be multimedia data such as advertise data including entertainment, discounts, coupons, and other promotional material. In the embodiment, the first electronic device 1 includes a storage unit 11, an input unit 12, a control unit 13, and a wireless connection unit 14 such as a Bluetooth® unit 14 in one embodiment.

The storage unit 11 stores a variety of contents. The input unit 12 is provided for a publisher to select a stored content. The control unit 13 obtains the selected content according to the selection input from the input unit 12, combines the selected content with an ID packet of the first electronic device 1 to form a combined ID packet, and then employs the combined ID packet as a new ID packet of the first electronic device 1, thereby allowing at least one second electronic device 2 to directly obtain the selected content through the new ID packet. More specifically, the ID packet includes the name of the first electronic device 1. In the embodiment, the control unit 13 adds the selected content to the end of the ID packet.

In one embodiment, after employing the combined ID packet as the new ID packet of the first electronic device 1, the control unit 13 further controls the Bluetooth® unit 14 to broadcast with Bluetooth® signal within an effective range after the Bluetooth® unit 14 is turned on, and the Bluetooth® signal includes an inquiry command. In the embodiment, the control unit 13 controls the Bluetooth® unit 14 of the first electronic device 1 to be automatically turned on after combining the selected content with the ID packet of the first electronic device 1. Referring to FIG. 2, the second electronic device 2 includes a wireless connection unit 21 such as a Bluetooth® unit 21 in one embodiment. When at least one second electronic device 2 responds to the inquiry command via the Bluetooth® unit 21, the control unit 13 of the first electronic device 1 then generates a connecting request including the new ID packet, and transmits the connecting request including the new ID packet to the responding second electronic device 2 via the Bluetooth® unit 14, thereby the selected content can be obtained by the second electronic device 2 without the need to make a connection between the first and the second electronic devices 1, 2. In the embodiment, the second electronic device 2 further includes a control unit 22, and the control unit 22 is configured to extract the selected from the new ID packet of the first electronic device 1 and control the second electronic device 2 to display the extracted content.

In an alternative embodiment, the first electronic device 1 does not need to transmit the connecting request including the new ID packet to the second electronic device 2. In this case, after employing the combined ID packet as the new ID packet of the first electronic device 1, the control unit 13 controls the Bluetooth® unit 14 to broadcast with Bluetooth® signal within an effective range after the Bluetooth® unit 14 is turned on. When the second electronic device 2 enters the effective range of the broadcasted Bluetooth® signal after the Bluetooth® unit 21 is turned on, the second electronic device 2 can find the first electronic device 1 through communication between the Bluetooth® units 14, 21 thereof and then obtain the new ID packet of the first electronic device 1. More specifically, the new ID packet including the selected content is displayed on the second electronic device 2, thereby the first and the second electronic devices 1, 2 can share contents without the need to make a connection between the first and the second electronic devices 1, 2. Therefore, the selected content can be easily obtained by the second electronic device 2 when the second electronic device 2 is within the predetermined range of the Bluetooth® signal and the Bluetooth® unit 21 of the second electronic device 2 device is turn on. In the embodiment, the control unit 22 of the second electronic device 2 extracts the selected content from the new ID packet of the first electronic device 1 and controls the second electronic device 2 to display the extracted content.

In yet another alternative embodiment, the first electronic device 1 does not need to transmit the connecting request including the new ID packet to the second electronic device 2. After combining the selected content with the ID packet of the first electronic device 1 to form the combined ID packet, the control unit 13 of the first electronic device 1 further obtains a current time, records the obtained current time in the combined ID packet, employs the combined ID packet with the obtained current time as a new ID packet of the first electronic device 1, and controls the Bluetooth® unit 14 to broadcast with Bluetooth® signal within an effective range. When the second electronic device 2 finds at least one first electronic device 1 through communication between the Bluetooth® units 14, 21 thereof and obtains the new ID packet of each first electronic device 1, the control unit 22 of the second electronic device 2 further determines whether more than one of the first electronic device 1 is found. If so, the control unit 22 identifies the current time recorded in the new ID packet of each first electronic device 1, and then controls the second electronic device 2 to display a list of the new ID packets according to the identified current time, for example, the new ID packet with a latest current time is allowed to be display on top of the list.

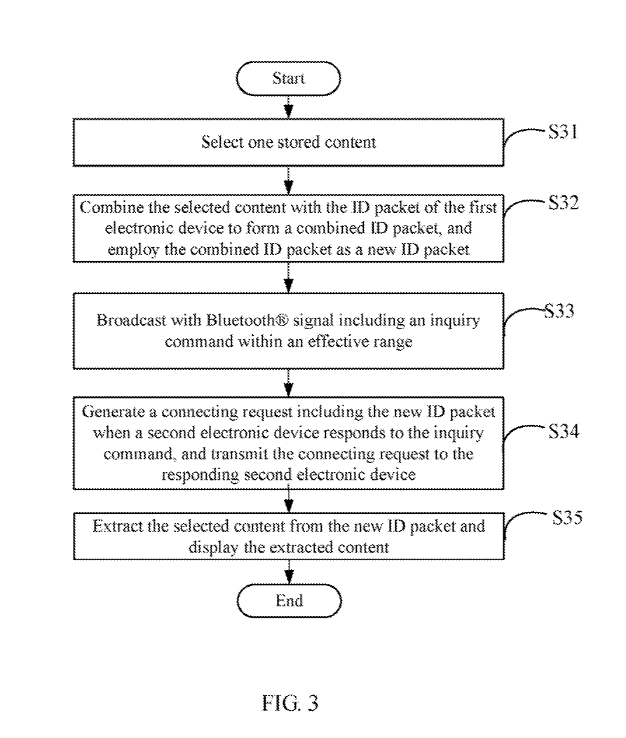

FIG. 3 is a flowchart of a method of sharing contents via a Bluetooth® network between the first and the second electronic devices 1, 2, according to another exemplary embodiment.

In step S31, through the input unit 12, the publisher selects one content stored in the storage unit 11.

In step S32, the control unit 13 of the first electronic device 1 combines the selected content with the ID packet of the first electronic device 1 to form a combined ID packet, and employs the combined ID packet as a new ID packet of the first electronic device 1.

In step S33, the control unit 13 controls the Bluetooth® unit 14 to broadcast with Bluetooth® signal including an inquiry command within an effective range after the Bluetooth® unit 14 is turned on.

In step S34, the control unit 13 of the first electronic device 1 generates a connecting request including the new ID packet when at least one second electronic device 2 responds to the inquiry command via the Bluetooth® unit 21, and transmits the connecting request including the new ID packet to the responding second electronic device 2 via the Bluetooth® unit 14.

In step S35, the control unit 22 of the second electronic device 2 extracts the selected content from the new ID packet of the first electronic device 1 and control the second electronic device 2 to display the extracted content.

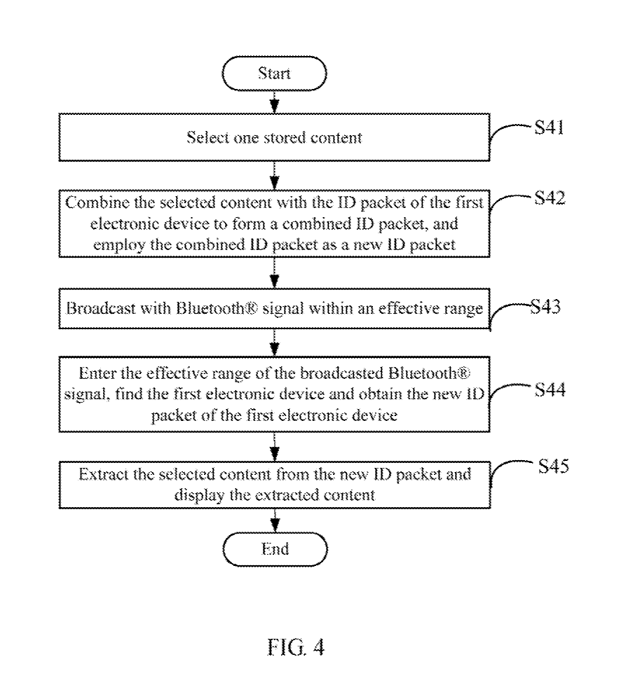

FIG. 4 is a flowchart of a method of sharing contents via a Bluetooth® network between the first and the second electronic devices 1, 2, according to another exemplary embodiment.

In step S41, through the input unit 12, the publisher select one content stored in the storage unit 11.

In step S42, the control unit 13 of the first electronic device 1 combines the selected content with the ID packet of the first electronic device 1 to form a combined ID packet, and employs the combined ID packet as a new ID packet of the first electronic device 1.

In step S43, the control unit 13 controls the Bluetooth® unit 14 to broadcast with Bluetooth® signal within an effective range after the Bluetooth® unit 14 is turned on.

In step S44, the second electronic device 2 finds the first electronic device 1 through communication between the Bluetooth® units 14, 21 thereof when the second electronic device 2 enters the effective range of the broadcasted Bluetooth® signal, and then obtains the new ID packet of the first electronic device 1.

In step S45, the control unit 22 of the second electronic device 2 extracts the selected from the new ID packet of the first electronic device 1 and control the second electronic device 2 to display the extracted content.

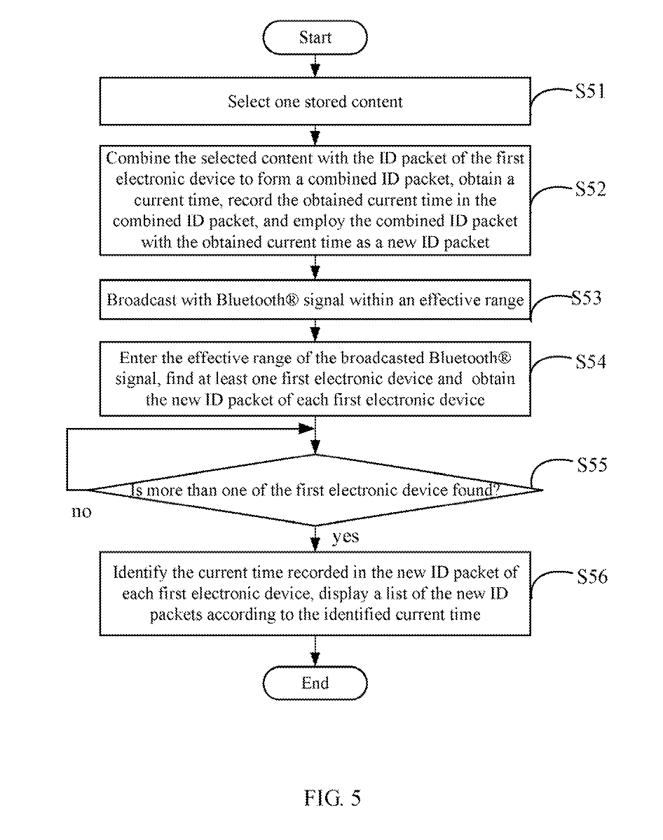

FIG. 5 is a flowchart of a method of sharing contents via a Bluetooth® network between the first and the second electronic devices 1, 2, according to yet another exemplary embodiment

In step S51, through the input unit 12, the publisher select one content stored in the storage unit 11.

In step S52, the control unit 13 of the first electronic device 1 combines the selected content with the ID packet of the first electronic device 1 to form a combined ID packet, obtains a current time, records the obtained current time in the combined ID packet, and employs the combined ID packet with the obtained current time as a new ID packet of the first electronic device 1.

In step S53, the control unit 13 controls the Bluetooth® unit 14 to broadcast with Bluetooth® signal within an effective range after the Bluetooth® unit 14 is turned on.

In step S54, the second electronic device 2 finds at least one first electronic device 1 through communication between the Bluetooth® units 14, 21 thereof when the second electronic device 2 enters the effective range of the broadcasted Bluetooth® signal after the Bluetooth® unit 21 is turned on, and then obtains the new ID packet of each first electronic device 1.

In step S55, the control unit 22 of the second electronic device 2 determines if more than one of the first electronic device 1 is found, if yes, the procedure goes to step S56; otherwise, the procedure goes back to step S55.

In step S56, the control unit 22 identifies the current time recorded in the new ID packet of each first electronic device 1, and then controls the second electronic device 2 to display a list of the new ID packets according to the identified current time.

Although the present disclosure has been described in accordance with the embodiments shown, one of ordinary skill in the art will readily recognize that there could be variations to the embodiments and those variations would be within the spirit and scope of the present disclosure. Accordingly, many modifications may be made by one of ordinary skill in the art without departing from the spirit and scope of the appended claims.

What is claimed is:

1. An electronic device capable of sharing contents via a wireless network with other electronic devices, the electronic device comprising:
a storage unit to store a plurality of contents;
an input unit;
a wireless connection unit; and
a control unit to obtain one of the contents from the storage unit according to a selection signal from the input unit, combine the selected content with an ID packet of the electronic device to form a combined ID packet, and employ the combined ID packet as a new ID packet of the electronic device, thereby allowing other electronic devices to directly obtain the selected content through the new ID packet.

2. The electronic device as described in claim 1, wherein the control unit is further configured to control the wireless connection unit to broadcast with wireless signal comprising an inquiry command within an effective range after employing the combined ID packet as the new ID packet of the electronic device, generate a connecting request comprising the new ID packet when other electronic device responds to the inquiry command, and transmit the connecting request comprising the new ID packet to the responding electronic device via the wireless connection unit, thereby the selected content can be obtained by the responding electronic device.

3. The electronic device as described in claim 1, wherein the control unit is further configured to control the wireless connection unit to broadcast with wireless signal within an effective range after employing the combined ID packet as the new ID packet of the electronic device, wherein when other electronic device comprising a wireless connection unit enters the effective range of the broadcasted wireless signal, the said other electronic device is capable of finding the electronic device through communication between the wireless connection units thereof and then obtain the new ID packet of the found electronic device comprising the selected content.

4. The electronic device as described in claim 1, wherein the wireless connection unit is a Bluetooth® unit, and the control unit is configured to control the Bluetooth® unit to broadcast with Bluetooth® signal within an effective range.

5. The electronic device as described in claim 1, wherein the control unit is configured to add the selected content to an end of the ID packet.

6. The electronic device as described in claim 1, wherein the control unit is further configured to control the wireless connection unit to be automatically turned on after combining the selected content with the ID packet of the electronic device.

7. A method for sharing contents via a wireless network between a first electronic device and a second electronic device each comprising a wireless connection unit, the method comprising:
selecting one of the contents stored in the first electronic device;
combining the selected content with an ID packet of the first electronic device to form a combined ID packet; and
employing the combined ID packet as a new ID packet of the first electronic device, thereby allowing at least one second electronic devices to directly obtain the selected content through the new ID packet.

8. The method as described in claim 7, wherein the step employing the combined ID packet as a new ID packet of the first electronic device, thereby allowing at least one second electronic devices to directly obtain the selected content through the new ID packet further comprises:
broadcasting with wireless signal comprising an inquiry command within an effective range;
generating a connecting request comprising the new ID packet when at least one second electronic device responds to the inquiry command; and
transmitting the connecting request comprising the new ID packet to the responding second electronic device, thereby the selected content can be obtained by the responding second electronic device.

9. The method as described in claim 7, wherein the step employing the combined ID packet as a new ID packet of the first electronic device, thereby allowing at least one second electronic devices to directly obtain the selected content through the new ID packet further comprises:
broadcasting with wireless signal within an effective range;
finding at least one of the first electronic device when the second electronic device enters the effective range of the broadcasted wireless signal; and obtaining the new ID packet comprising the selected content.

10. The method as described in claim 9, wherein the new ID packet of the first electronic device comprises the combined ID packet and a current time when the selected content and the ID packet are combined, and the step finding at least one of the first electronic device when the second electronic device enters the effective range of the broadcasted wireless signal and obtaining the new ID packet comprising the selected content further comprises:
determining whether more than one of the first electronic device is found;
identifying the current time recorded in the new ID packet of each first electronic device when more than one of the first electronic device is found;
controlling the second electronic device to display a list of the new ID packets according to the identified current time.
